(19) United States
(12) Patent Application Publication
(10) Pub. No.: US 2026/0178119 A1
(43) Pub. Date: Jun. 25, 2026

(54) IMAGE GENERATION METHOD, DISPLAY DEVICE AND SERVER

(71) Applicant: BOE TECHNOLOGY GROUP CO., LTD., Beijing (CN)

(72) Inventors: Chaoquan YAO, Beijing (CN); Chao ZHENG, Beijing (CN); Honglei ZHANG, Beijing (CN); Jinghua MIAO, Beijing (CN); Qingwen FAN, Beijing (CN); Juanjuan SHI, Beijing (CN); Yuanxing ZHAO, Beijing (CN); Xiao CHU, Beijing (CN); Xiying ZHANG, Beijing (CN)

(21) Appl. No.: 19/128,604

(22) PCT Filed: Oct. 31, 2023
(86) PCT No.: PCT/CN2023/128393

§ 371 Date: May 9, 2025

(51) Int. Cl. G06F 3/01

(52) U.S. Cl. CPC G06F 3/013

(57) ABSTRACT

An image generation method, including: sending an acquired eye position of a user at a current moment t1 to a server; receiving an initial gaze area, second-resolution image data, and initial first-resolution image data of an image to be displayed from the server, where the second-resolution image data has a resolution lower than the initial first-resolution image data; in response to the fact that the acquired actual eye position at a moment t2 is within the initial gaze area, taking the initial gaze area of the image to be displayed as the actual gaze area of the image to be displayed, and taking the initial first-resolution image data of the image to be displayed as the actual first-resolution image data; and generating the image to be displayed based on at least the second-resolution image data of the image to be displayed and the actual first-resolution image data.

### TECHNICAL FIELD

The present disclosure belongs to the technical field of virtual reality, and specifically relates to an image generation method, a display device, a server, an electronic device, and a computer-readable non-transitory storage medium.

### BACKGROUND

With the rapid development of the virtual reality (VR) game industry, the involved high-load tasks such as rendering have very high demands on computing resources, and typically require a high-performance game console, resulting in high cost of VR games and failure to meet people's requirement of playing VR games anytime and anywhere. With the idea of end-cloud collaboration, Cloud VR implements separation of VR game rendering and VR game interaction, where a cloud server completes rendering of a game according to the received interaction instructions (such as eye tracking data), and transmits game pictures to a terminal for display through a wireless network. Cloud VR can significantly reduce the cost of the VR game terminal as well as performance requirements on the VR processor, while enabling a user to access a network to play VR games anytime anywhere.

A display device (e.g., HMD) starts an eyeball tracking module to acquire eyeball tracking data, and then uploads the tracking data to an image source terminal (e.g., a film source server, i.e., a cloud server) through a coding and network transmission module. After receiving the eyeball tracking data, a network transmission and codec module of the image source terminal calculates a dynamic high-definition expansion area. Then an image processing module renders full low-definition images, and renders high-definition images according to the calculated area, and then transmits shunted images to a display device, where the display device decodes the images and splices a gaze area and a non-gaze area to display a final image. While viewpoint images of the HMD are transmitted to the cloud server and displayed, the eye position may have changed, causing a delay in the eye tracking area and thus a dizzy feeling.

### SUMMARY

To solve at least one of the technical problems in the existing art, the present disclosure provides an image generation method, a display device, a server, an electronic device, and a computer-readable non-transitory storage medium.

In a first aspect, an embodiment of the present disclosure provides an image generation method applied to a display device, including:
sending an acquired eye position of a user at a current moment t1 to a server;
receiving an initial gaze area, second-resolution image data, and initial first-resolution image data of an image to be displayed from the server, wherein the second-resolution image data has a resolution lower than the initial first-resolution image data, an image generated corresponding to the initial first-resolution image data has a first resolution, an image generated corresponding to the second-resolution image data has a second resolution, and the first resolution is higher than the second resolution; and
wherein the initial gaze area, the second-resolution image data, and the initial first-resolution image data of the image to be displayed are obtained by the server through the following steps: by the server,
predicting an eye position at a moment t2 according to the eye position at the moment t1 and source data, and obtaining, based on the eye position at the moment t1 and the predicted eye position at the moment t2, an initial gaze area and an initial non-gaze area of the image to be displayed, wherein a first time difference Δt is present between the moment t2 and the moment t1; obtaining, according to the initial gaze area and the source data, the second-resolution image data and the initial first-resolution image data;
in response to the fact that the acquired actual eye position at the moment t2 is within the initial gaze area, taking the initial gaze area of the image to be displayed as the actual gaze area of the image to be displayed, and taking the initial first-resolution image data of the image to be displayed as the actual first-resolution image data; and
generating the image to be displayed based on at least the second-resolution image data of the image to be displayed and the actual first-resolution image data.

The method further includes: in response to the fact that the acquired actual eye position at the moment t2 is not within the initial gaze area, determining, based on actual gaze areas and actual first-resolution image data of N frames of display images previous to the image to be displayed, an actual gaze area and actual first-resolution image data of the image to be displayed at the moment t2, where 0<N≤10, and N is a positive integer.

The step of determining, based on actual gaze areas and actual first-resolution image data of N frames of display images previous to the image to be displayed, an actual gaze area and actual first-resolution image data of the image to be displayed at the moment t2 includes:
determining a similarity between the actual first-resolution image data of N frames of display images previous to the image to be displayed and the initial first-resolution image data of the image to be displayed, and a position relationship between the actual eye position at the moment t2 and the actual gaze areas of the N frames of display images previous to the image to be displayed;
taking display images with the actual gaze areas containing the actual eye position at the moment t2, among the N frames of display images previous to the image to be displayed, as candidate display images; and
taking the actual first-resolution image data of a frame in the candidate display images, the actual first-resolution image data of which frame has the highest similarity to the initial first-resolution image data of the image to be displayed, as the actual first-resolution image data of the image to be displayed.

The step of generating the image to be displayed based on at least the second-resolution image data of the image to be displayed and the actual first-resolution image data includes:
acquiring necessary processing performance of the display device for processing the image to be displayed;
in response to the fact that the necessary processing performance does not exceed a preset processing performance threshold, generating the image to be displayed according to the actual first-resolution image data and the second-resolution image data; and in response to the fact that the necessary processing performance exceeds the preset processing performance threshold, clipping the actual gaze area, determining clipped actual first-resolution image data according to the actual first-resolution image data, and generating the image to be displayed according to the clipped actual first-resolution image data and the second-resolution image data.

The processing performance includes a processing speed, and acquiring necessary processing performance of the display device for processing the image to be displayed includes:
calculating a necessary processing speed of the display device, based on the actual gaze area, the actual non-gaze area, the actual first-resolution image data, and the second-resolution image data of the image to be displayed.

The processing performance includes a processing speed, and acquiring necessary processing performance of the display device for processing the image to be displayed includes:
acquiring processing speeds of the display device for processing M frames of display images previous to the image to be displayed;
determining, according to the processing speeds for the M frames of display images previous to the image to be displayed, a necessary processing speed of the display device for processing the image to be displayed; where 0<M≤10, and M is a positive integer.

Determining, according to the processing speeds for the M frames of display images previous to the image to be displayed, the necessary processing speed of the display device for processing the image to be displayed includes:
determining, according to an average of the processing speeds for the M frames of display images previous to the image to be displayed, the necessary processing speed of the display device for processing the image to be displayed.

The processing performance includes a rendering capability; and acquiring necessary processing performance of the display device for processing the image to be displayed includes:
acquiring first data information and second data information of the image to be displayed, wherein the first data information includes at least a number of objects and a number of layers in the actual gaze area, and the second data information includes at least a number of objects and a number of layers in the actual non-gaze area;
determining a size of an image corresponding to the actual gaze area according to a product of the number of objects in the first data information and a first numerical value; determining a size of an image corresponding to the non-gaze area according to a product of the number of objects in the second data information and a second numerical value;
determining, according to the first data information and the second data information, a processing complexity of the actual gaze area and a processing complexity of the actual non-gaze area of the image to be displayed; and
calculating a necessary rendering capability of the display device, according to the processing complexity of the actual gaze area, the processing complexity of the actual non-gaze area, the size of the image corresponding to the actual gaze area, the size of the image corresponding to the actual non-gaze area, a first target resolution and a first target refresh frequency of the actual gaze area, and a second target resolution and a second target refresh frequency of the actual non-gaze area of the image to be displayed.

Cutting the actual gaze area includes:
determining, according to the actual eye position at the moment t2 and pre-stored width and height of the gaze area, positions of four vertexes of the clipped actual gaze area; and
clipping the actual gaze area according to the determined positions of the four vertexes of the clipped actual gaze area.

The display device includes a first mode and a second mode; and the method further includes:
when the necessary processing performance of the display device does not exceed the preset processing performance threshold, respectively predicting, according to the actual non-gaze area, the actual gaze area, the actual first-resolution image data and the second-resolution image data of the image to be displayed, and a current battery level, respective remaining playing time of the display device in the first mode and the second mode;
when the predicted remaining playing time of the display device in the first mode is longer than or equal to playing time preset by a user, generating the image to be displayed according to the actual first-resolution image data and the second-resolution image data;
when the predicted remaining playing time of the display device in the first mode is less than the playing time preset by the user, and the predicted remaining playing time of the display device in the second mode is longer than or equal to the playing time preset by the user, clipping the actual gaze area, determining the clipped actual first-resolution image data according to the actual first-resolution image data, and generating the image to be displayed according to the clipped actual first-resolution image data and the second-resolution image data; and
when the predicted remaining playing time of the display device in the second mode is less than the playing time preset by the user, clipping the actual gaze area, determining the clipped actual first-resolution image data according to the actual first-resolution image data, and generating the image to be displayed according to the clipped actual first-resolution image data and the second-resolution image data, and sending prompt information to the user.

In a second aspect, an embodiment of the present disclosure provides an image generation method applied to a server, including:
predicting an eye position at a moment t2 according to an eye position of a user at a current moment t1 and source data sent from a display device, wherein a first time difference Δt is present between the moment t2 and the moment t1;
obtaining, based on the eye position at the moment t1 and the predicted eye position at the moment t2, an initial gaze area and an initial non-gaze area of the image to be displayed, wherein
obtaining, according to the initial gaze area and the source data, second-resolution image data and initial first-resolution image data, wherein an image generated corresponding to the initial first-resolution image data has a first resolution, an image generated corresponding to the second-resolution image data has a second resolution, and the first resolution is higher than the second resolution; and
sending the predicted eye position at the moment t2, the initial gaze area, the initial non-gaze area, the second-resolution image data, and the initial first-resolution image data to the display device, such that the display device determines the second-resolution image data and the actual first-resolution image data of the image to be displayed and generates the image to be displayed.

The method further includes:
acquiring a network transmission rate; and
in response to the fact that the network transmission speed is lower than a preset rate, transmitting only the second-resolution image data to the display device.

In a third aspect, an embodiment of the present disclosure provides a display device, including:
an eyeball tracking module configured to acquire an eye position in real time;
a first transmitting module configured to transmit the eye position to a server;
a first receiving module configured to receive an initial gaze area, second-resolution image data, and initial first-resolution image data of an image to be displayed from the server, wherein the initial gaze area, the second-resolution image data, and the initial first-resolution image data of the image to be displayed are obtained by the server through the following steps: by the server,
predicting an eye position at a moment t2 according to the eye position at a moment t1 and source data, and obtaining, based on the eye position at the moment t1 and the predicted eye position at the moment t2, the initial gaze area and an initial non-gaze area of the image to be displayed, wherein a first time difference Δt is present between the moment t2 and the moment t1; obtaining, according to the initial gaze area and the source data, the second-resolution image data and the initial first-resolution image data; wherein an image generated corresponding to the initial first-resolution image data has a first resolution, an image generated corresponding to the second-resolution image data has a second resolution, and the first resolution is higher than the second resolution;
a judgment module configured to judge whether an acquired actual eye position at the moment t2 is within the initial gaze area;
a data determination module configured to, in response to the fact that the acquired actual eye position at the moment t2 is within the initial gaze area, take the initial gaze area of the image to be displayed as an actual gaze area of the image to be displayed, and take the initial first-resolution image data of the image to be displayed as actual first-resolution image data; and
an image generation module configured to generate the image to be displayed based on at least the second-resolution image data of the image to be displayed and the actual first-resolution image data.

In a fourth aspect, an embodiment of the present disclosure provides a server, including:
a prediction module configured to predict an eye position at a moment t2 according to an eye position of a user at a current moment t1 and source data sent from a display device, wherein a first time difference Δt is present between the moment t2 and the moment t1;
an area determination module configured to obtain, based on the eye position at the moment t1 and the predicted eye position at the moment t2, an initial gaze area and an initial non-gaze area of the image to be displayed;
a data rendering module configured to obtain, according to the initial gaze area and the source data, second-resolution image data and initial first-resolution image data, wherein an image generated corresponding to the initial first-resolution image data has a first resolution, an image generated corresponding to the second-resolution image data has a second resolution, and the first resolution is higher than the second resolution; and
a second transmitting module configured to send the predicted eye position at the moment t2, the initial gaze area, the initial non-gaze area, the second-resolution image data, and the initial first-resolution image data to the display device, such that the display device determines the second-resolution image data and actual first-resolution image data of the image to be displayed and generates the image to be displayed.

In a fifth aspect, an embodiment of the present disclosure provides an electronic device, including:
one or more processors;
a memory having one or more programs stored thereon which,
when executed by the one or more processors, cause the one or more processors to implement any image generation method as described above.

In a sixth aspect, an embodiment of the present disclosure provides a computer-readable non-transitory storage medium having a computer program stored thereon which, when executed by a processor, causes steps of any image generation method as described above to be implemented.

### BRIEF DESCRIPTION OF DRAWINGS

FIG. 1 is a flowchart of an image generation method (applied to a display device) according to an embodiment of the present disclosure.

FIG. 2 is a flowchart of another image generation method (applied to a display device) according to an embodiment of the present disclosure.

FIG. 3 is a flowchart of yet another image generation method (applied to a display device) according to an embodiment of the present disclosure.

FIG. 4 is a flowchart of an image generation method (applied to a server) according to an embodiment of the present disclosure.

FIG. 5 is a schematic diagram of a display device according to an embodiment of the present disclosure.

FIG. 6 is a schematic diagram of a server according to an embodiment of the present disclosure.

FIG. 7 is a schematic diagram of an electronic device according to an embodiment of the present disclosure.

### DETAIL DESCRIPTION OF EMBODIMENTS

To improve understanding of the technical solution of the present disclosure for those skilled in the art, the present disclosure will be described in detail with reference to accompanying drawings and specific implementations.

Unless otherwise defined, technical or scientific terms used in the present disclosure are intended to have general meanings as understood by those skilled in the art to which the present disclosure belongs. The words “first”, “second” and similar terms used in the present disclosure do not denote any order, quantity, or importance, but are used merely for distinguishing different components from each other. Likewise, the words “a”, “an”, or “the” and similar referents do not denote a limitation of quantity, but rather denote the presence of at least one. The word “comprise” or “include” or the like means that the element or item preceding the word contains elements or items that appear after the word or equivalents thereof, but does not exclude other elements or items. The terms “connected” or “coupled” and the like are not restricted to physical or mechanical connection, but may include electrical connection, either direct or indirect. The words “upper”, “lower”, “left”, “right”, or the like are merely used to indicate a relative positional relationship, and when an absolute position of the described object is changed, the relative positional relationship may be changed accordingly.

Before an introduction of the embodiments of the present disclosure, it should be noted that the image generation method according to the embodiments of the present disclosure is applied to a display device on one hand and applied to a cloud server on the other hand, but the final image display in the two application scenarios are both achieved through information interaction between the display device and the cloud server. Next, applications of the image generation method according to the embodiments of the present disclosure to a display device and a cloud server are described, respectively. In addition, for convenience of description, image data corresponding to a first-resolution image is referred to as high-definition image data, and image data corresponding to a second-resolution image is referred to as low-definition image data. Accordingly, a gaze area corresponds to an area where the high-definition image data is located, and a non-gaze area corresponds to other positions of the display device.

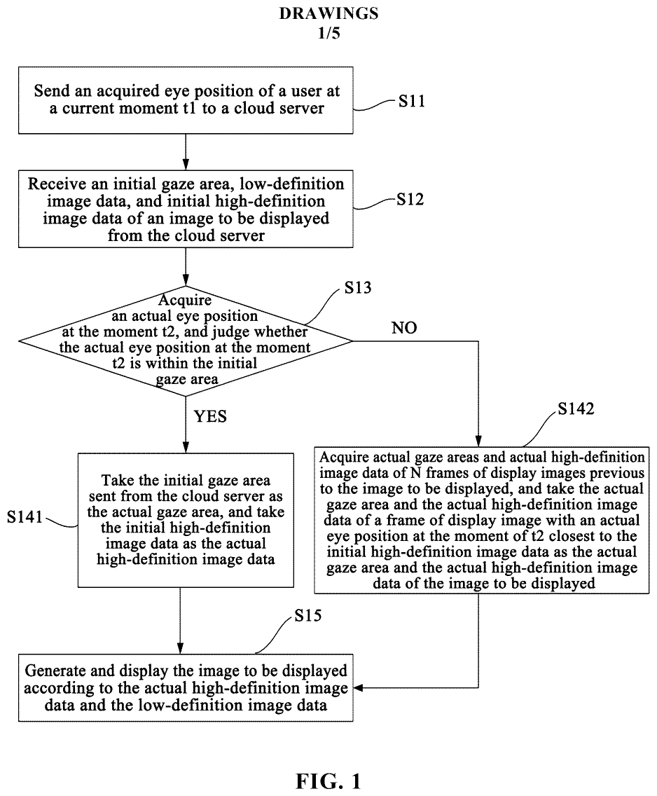

In a first aspect, an embodiment of the present disclosure provides an image generation method, and FIG. 1 is a flowchart of an image generation method (applied to a display device) according to an embodiment of the present disclosure. As shown in FIG. 1, the method is applied to a display device. The method may specifically include the following steps S11 to S15. At S11, sending an acquired eye position of a user at a current moment t1 to a cloud server.

Specifically, an eyeball tracking module is integrated into the display device, and configured to acquire eyeball tracking data of the user in real time, i.e., acquire an eye position at the moment t1. The eye position may be represented by coordinates, and the eye position at the moment t1 is denoted as T1(x1, y1).

At S12, receiving an initial gaze area, low-definition image data, and initial high-definition image data of an image to be displayed from the cloud server.

Specifically, the initial gaze area, the low-definition image data, and the initial high-definition image data of the image to be displayed, sent from the cloud server in step S12 are obtained by the following steps S01 to S02.

At S01, by the server, predicting an eye position at a moment t2 according to the eye position at the moment t1 and the received source data, and obtaining, based on the eye position at the moment t1 and the predicted eye position at the moment t2, the initial gaze area of the image to be displayed. A first time difference Δt is present between the moment t2 and the moment t1, i.e., t2=t1+Δt. It should be noted that Δt mainly includes round-trip time consumed for data transmission over the network and time consumed for image processing. The source data refers to image data in a video stream used to generate an image to be displayed.

In some examples, step S01 may include the following steps 1) to 4).

At step 1), correcting the acquired eye position at the moment t1 based on eye positions of n time nodes before the moment t1 and the source data.

Step 1) includes: a. taking the eye position at the moment t1 as a center of a circle, performing edge extraction in the circle with a radius r to obtain an edge image; and b. determining a position with a maximum edge density in the edge image, and correcting by taking the position as an eye gaze position at the moment t1, i.e., a true eye position at the moment t1.

At step 2), fitting the corrected eye position at the moment t1 by a nonlinear equation, and determining an eye gaze position p at a moment t, to obtain an eye motion trajectory function p=f(t).

At step 3), interpolating the eye motion trajectory function to obtain a prediction result p2=f(t2) of the eye position at the moment t2, i.e., a predicted eye position T2(x2, y2) at the moment t2.

At step 4), obtaining, based on the eye position at the moment t1 and the predicted eye position at the moment t2, the initial gaze area of the image to be displayed. For example: given that the eye position at the moment t1 is T1(x1, y1), the predicted eye position at the moment t2 is T2(x2, y2), a preset high-definition range is (±P, ±P), and the correction coefficient is k, a first area is determined by taking T1(x1, y1) as the center and combining the preset high-definition range (±P, ±P). Similarly, a second area is determined by taking T2(x2, y2) as the center and combining the preset high-definition range (±P, ±P). Then the first area and the second area are fitted to obtain an initial gaze area

$$( ( \frac{{x}_{1} + {x}_{2}}{2} ) \pm ( k \vert \frac{{x}_{1} - {x}_{2}}{2} \vert + P ) , ( \frac{{y}_{1} + {y}_{2}}{2} ) \pm ( k \vert \frac{{y}_{1} - {y}_{2}}{2} \vert + P ) ) ,$$

as well as an initial non-gaze area of the image to be displayed (other areas except the initial gaze area are all initial non-gaze areas).

At S02, rendering, according to the initial gaze area and frame image data to be displayed at the moment of t2, to obtain an initial low-definition image and an initial high-definition image.

While determining the initial gaze area of the image to be displayed, the cloud server fully considers the eye position T1(x1, y1) at the moment t1 and the predicted eye position T2(x2, y2) at the moment t2, so that original coordinate position missing due to the prediction accuracy is avoided. Then, the cloud server sends the determined initial gaze area, initial low-definition image and initial high-definition image to the display device.

At S13, acquiring an actual eye position at the moment t2, and judging whether the actual eye position at the moment t2 is within the initial gaze area; performing step S141 if the actual eye position at the moment t2 is within the initial gaze area, and performing step S142 if the actual eye position at the moment t2 is not within the initial gaze area.

Specifically, while the cloud server sends the initial gaze area, the low-definition image data and the initial high-definition image data of the image to be displayed to the display device, the eyeball tracking module of the display device acquires an actual eye position T2′(x2′, y2′) at the current moment t2, and at this time, the display device can judge whether the actual eye position is within the initial gaze area. In other words, the display device needs to judge whether x2′ and y2′ satisfy the following magnitude relationship at the same time:

$$( \frac{{x}_{1} + {x}_{2}}{2} ) - ( k \vert \frac{{x}_{1} - {x}_{2}}{2} \vert ) \leq {x}_{2}^{′} \leq ( \frac{{x}_{1} + {x}_{2}}{2} ) + ( k \vert \frac{{x}_{1} - {x}_{2}}{2} \vert ) ;$$

$$( \frac{{y}_{1} + {y}_{2}}{2} ) - ( k \vert \frac{{y}_{1} - {y}_{2}}{2} \vert ) \leq {y}_{2}^{′} \leq ( \frac{{y}_{1} + {y}_{2}}{2} ) + ( k \vert \frac{{y}_{1} - {y}_{2}}{2} \vert ) .$$

If the actual eye position is within the initial gaze area, it indicates that the eye position at the moment t2 predicted by the cloud server is relatively accurate, and thus, the initial gaze area obtained based on the predicted eye position is also relatively accurate. If the actual eye position is not within the initial gaze area, it indicates that the eye position at the t2 moment predicted by the cloud server is deviated from the actual eye position, and thus, the initial gaze area obtained based on the predicted eye position is also deviated.

At S141, taking the initial gaze area sent from the cloud server as the actual gaze area, and taking the initial high-definition image data as the actual high-definition image data.

At S142, acquiring actual gaze areas and actual high-definition image data of N frames of display images previous to the image to be displayed, and taking the actual gaze area and the actual high-definition image data of a frame of display image with an actual eye position at the moment of t2 closest to the initial high-definition image data as the actual gaze area and the actual high-definition image data of the image to be displayed. In this embodiment, 0<N≤10, and N is a positive integer.

In some examples, in step S142, the display device may firstly determine a similarity between the actual high-definition image data of the N frames of display images previous to the image to be displayed and the initial high-definition image data of the image to be displayed, and whether the actual eye position at the moment t2 is within the actual gaze areas of the previous N frames of display images, take frames of display images with the actual eye position at the moment t2 within the actual gaze areas, among the previous N frames of display images, as candidate display images, and take the actual gaze area and the actual high-definition image data of one of the candidate display images with the highest similarity to the initial high-definition image data of the image to be displayed as the actual gaze area and the actual high-definition image data of the image to be displayed.

At S15, generating and displaying the image to be displayed according to the actual high-definition image data and the low-definition image data.

Specifically, in step S15, a processor of the display device may synthesize the obtained actual high-definition image data and low-definition image data into the image to be displayed and display the image.

According to the image generation method provided in the embodiments of the present disclosure, frame data of the image to be displayed is rendered in the cloud, which reduces the processing task amount of the display device, and significantly reduces the probability of stutter in the display device.

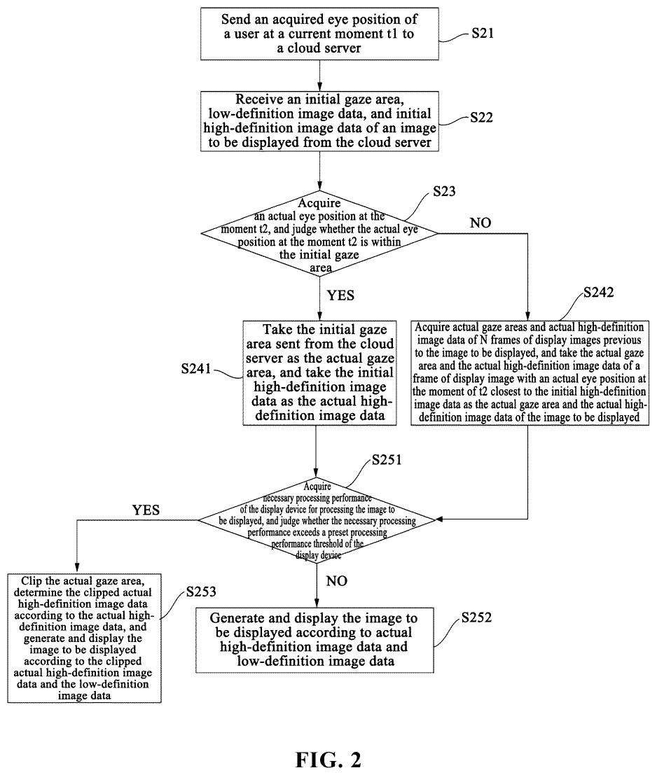

An embodiment of the present disclosure further provides an image generation method, and FIG. 2 is a flowchart of another image generation method (applied to a display device) according to an embodiment of the present disclosure. As shown in FIG. 2, the method is also applied to a display device, and includes steps S21 to S25, where only step S25 in this method is different from step S15 in the method described above, while other steps are the same as those in the above example. Therefore, only step S25 is described below. Step S25 may specifically include the following steps S251 to S253.

At S251, acquiring necessary processing performance of the display device for processing the image to be displayed, and judging whether the necessary processing performance exceeds a preset processing performance threshold of the display device. If the necessary processing performance of the display device does not exceed the preset processing performance threshold, step S252 is performed; and if the necessary processing performance of the display device exceeds the preset processing performance threshold, step S253 is performed.

At S252, generating and displaying the image to be displayed according to actual high-definition image data and low-definition image data.

At S253, clipping the actual gaze area, determining the clipped actual high-definition image data according to the actual high-definition image data, and generating and displaying the image to be displayed according to the clipped actual high-definition image data and the low-definition image data.

In some examples, the processing performance of the display device in step S251 may be a processing speed of the display device.

In one example, the processing performance of the display device may be the processing speed of the display device, the step of acquiring necessary processing performance of the display device for processing the image to be displayed in step S251 may specifically include: calculating a necessary processing speed of the display device, based on an actual gaze area, an actual non-gaze area, the actual high-definition image data, and the low-definition image data of the image to be displayed.

In one example, the processing performance of the display device may be the processing speed of the display device, the step of acquiring necessary processing performance of the display device for processing the image to be displayed in step S251 may specifically include: acquiring processing speeds of the display device for processing M frames of display images previous to the image to be displayed; and determining, according to the processing speeds for the M frames of display images previous to the image to be displayed, a necessary processing speed of the display device for processing the image to be displayed, where 0<M≤10, and M is a positive integer. For example: M=5. In some examples, determining, according to the processing speeds for the M frames of display images previous to the image to be displayed, the necessary processing speed of the display device for processing the image to be displayed includes: determining, according to an average of the processing speeds for the M frames of display images previous to the image to be displayed, the necessary processing speed of the display device for processing the image to be displayed.

In some examples, the processing performance of the display device may be a rendering capability of a processor in the display device. When the processing performance of the display device is the rendering capability of the processor of the display device, step S251 may specifically include the following steps S2511 to S2515.

At S2511, acquiring first data information and second data information of the image to be displayed. The first data information includes at least the number of objects and the number of layers in the actual gaze area, and the second data information includes at least the number of objects and the number of layers in the actual non-gaze area. It should be noted that the objects include, but are not limited to, people, objects, and the like.

In some examples, in step S2511, the display device may perform clustering on the low-definition image data to obtain the numbers of image clusters in the actual gaze area and the actual non-gaze area, that is, obtain the numbers of objects in the actual gaze area and the actual non-gaze area. Meanwhile, the display device may parse the actual high-definition image data and the low-definition image data respectively, to obtain the numbers of layers of the high-definition image data and the low-definition image data. In other words, first data information and second data information may be obtained in the above manner.

At S2512, determining a size of an image corresponding to the actual gaze area according to a product of the number of objects in the first data information and a first numerical value; and determining a size of an image corresponding to the actual non-gaze area according to a product of the number of objects in the second data information and a second numerical value. The first numerical value is a ratio of a size of the gaze area to a size of the display device; and the second numerical value is a ratio of a size of the non-gaze area to the size of the display device.

At S2513, determining, according to the first data information and the second data information, a processing complexity of the actual gaze area and a processing complexity of the actual non-gaze area of the image to be displayed.

In some embodiments, step S2513 may include: determining, by the display device, according to the first data information and the second data information, as well as a preset complexity database, a processing complexity of the image to be displayed. The preset complexity database may be pre-configured by the display device. The preset complexity database includes a correspondence relationship between both the first data information and the second data information and processing complexities. For example: when the first data information and the second data information are both numbers of objects, the preset complexity database includes a correspondence relationship between numbers of the objects and processing complexities. The larger the number of objects is, the higher the corresponding processing complexity will be. In this manner, the display device can quickly and accurately determine a processing speed for the image to be displayed according to the preset complexity database.

At S2514, calculating a necessary rendering capability of the processor in the display device, according to the processing complexity of the actual gaze area, the processing complexity of the actual non-gaze area, the size of the image corresponding to the actual gaze area, the size of the image corresponding to the actual non-gaze area, a first target resolution and a first target refresh frequency of the actual gaze area, and a second target resolution and a second target refresh frequency of the actual non-gaze area of the image to be displayed.

At S2515, comparing the necessary rendering capability with a preset rendering capability threshold of the display device. If the necessary rendering capability of the display device does not exceed the preset rendering capability threshold, the image to be displayed will be generated and displayed according to actual high-definition image data and low-definition image data. If the necessary processing performance of the display device exceeds the preset processing performance threshold, the actual gaze area is clipped, the clipped actual high-definition image data is determined according to the actual high-definition image data, and the image to be displayed is generated and displayed according to the clipped actual high-definition image data and the low-definition image data.

In some examples, the step of clipping the actual gaze area may specifically include: determining, according to the actual eye position T2′(x2′, y2′) at the moment t2 and pre-stored width and height (w, h) of the gaze area, coordinates of four vertexes of the clipped actual gaze area, (x2′−w/2, y2′−h/2), (x2′−w/2, y2′+h/2), (x2′+w/2, y2′+h/2), (x2′+w/2, y2′−h/2), and clipping the actual gaze area based on the coordinates of the four vertexes as the clipped actual gaze area. By reducing the size of the actual gaze area, smooth display is further guaranteed, and the display effect is improved.

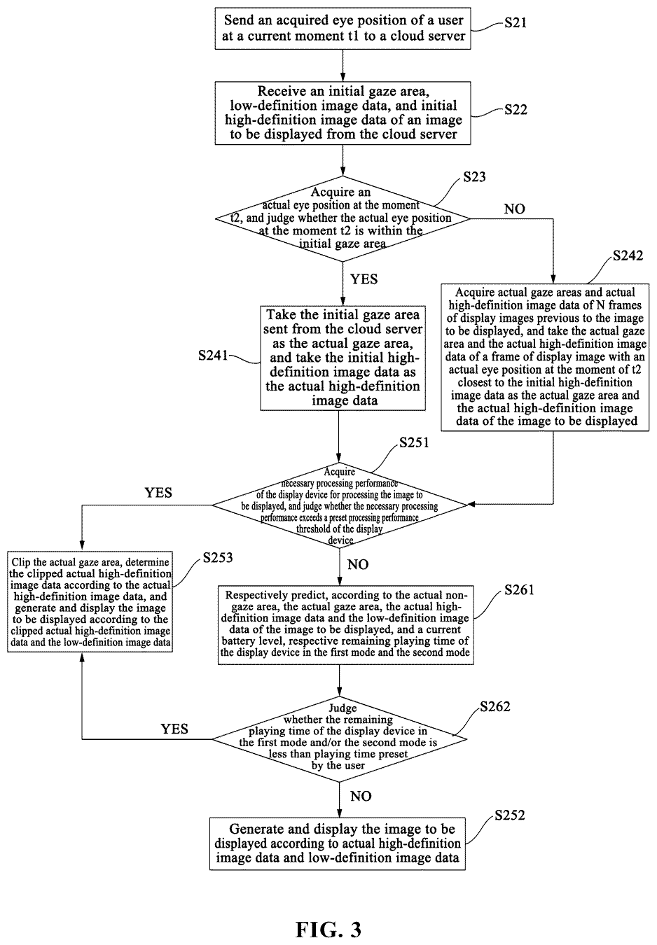

An embodiment of the present disclosure further provides an image generation method, and FIG. 3 is a flowchart of yet another image generation method (applied to a display device) according to an embodiment of the present disclosure. As shown in FIG. 3, the method is applied to a display device, and further includes step S26 on the basis of the above methods. The display device includes a first mode and a second mode. In the first mode, display is directly performed according to the actual high-definition image data and the low-definition image data, while in the second mode, the actual gaze area is firstly clipped, and then display is implemented according to the clipped actual gaze area. Specifically, step S26 includes the following steps S261 to S262.

At step S261, when the necessary processing performance of the display device does not exceed the preset processing performance threshold, respectively predicting, according to the actual non-gaze area, the actual gaze area, the actual high-definition image data and the low-definition image data of the image to be displayed, and a current battery level, respective remaining playing time of the display device in the first mode and the second mode.

It should be noted that when the device is started, the device may perform power consumption tests in the first mode and the second mode at two stages in a short time. That is, an average power consumption rate v1 in the first mode is tested in a time period Δt, and then an average power consumption rate v2 in the second mode is tested in a next time period Δt. Assuming that a total amount of electricity is S, the time occupied by the first mode is calculated as

$${t}_{1} = \frac{S - {v}_{2} \cdot T}{{v}_{1} - {v}_{2}} ,$$

and the time occupied by the second mode is calculated as

$${t}_{2} = T - \frac{S - {v}_{2} \cdot T}{{v}_{1} - {v}_{2}} .$$

At step S262, judging whether the remaining playing time of the display device in the first mode and/or the second mode is less than playing time preset by the user.

When the predicted remaining playing time of the display device in the first mode is longer than or equal to the playing time preset by the user, the step S252 of generating the image to be displayed according to the actual high-definition image data and the low-definition image data is performed.

When the predicted remaining playing time of the display device in the first mode is less than the playing time preset by the user, and the predicted remaining playing time of the display device in the second mode is longer than or equal to the playing time preset by the user, the step S253 of clipping the actual gaze area, determining the clipped actual high-definition image data according to the actual high-definition image data, and generating the image to be displayed according to the clipped actual high-definition image data and the low-definition image data is performed.

When the predicted remaining playing time of the display device in the second mode is less than the playing time preset by the user, the step S253 of clipping the actual gaze area, determining the clipped actual high-definition image data according to the actual high-definition image data, and generating the image to be displayed according to the clipped actual high-definition image data and the low-definition image data is performed.

In some examples, when the predicted remaining playing time of the display device in the second mode is less than the playing time preset by the user, prompt information may be sent to the user. At this time, the user may select to continue playing for the remaining time according to the prompt information until the battery runs out, or may select not to play temporarily, so as to ensure a good entertainment feeling of the user, and avoid a reduced entertainment feeling due to a sudden shutdown of the device during playing.

In some examples, when the necessary processing performance of the display device exceeds the preset processing performance threshold, the actual gaze area of the image to be displayed needs to be clipped regardless of the relationship between the playing time preset by the user and the predicted playing time in the first mode and the second mode.

According to the image processing method provided in the embodiments of the present disclosure, by rendering frame data of the image to be displayed in the cloud, the processing task amount of the display device is reduced, and the probability of stutter in the display device is significantly reduced; and further, data of the image to be displayed is further processed according to the necessary processing performance for the image to be displayed, the playing time and the like, so that the after-use experience is improved.

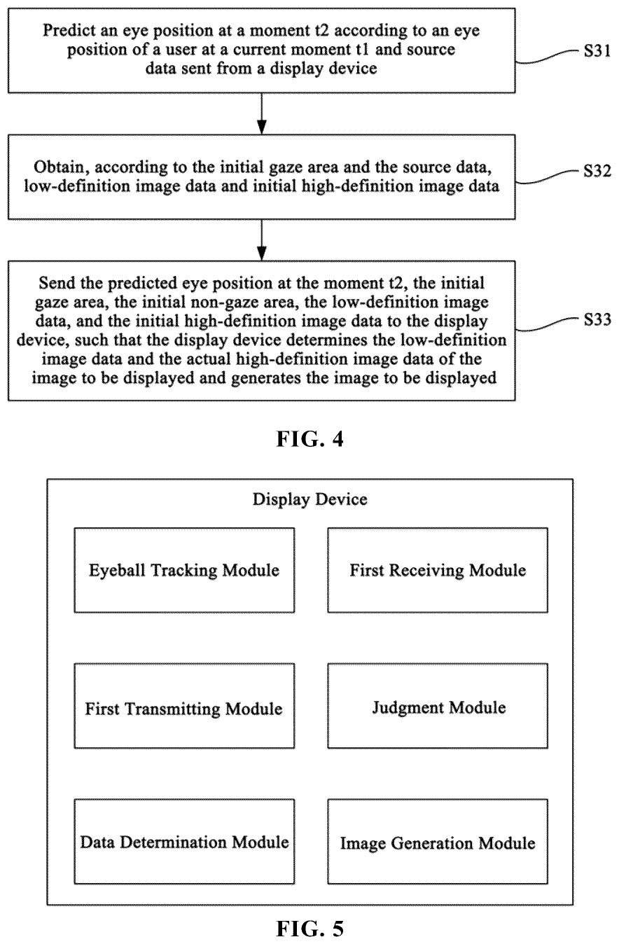

In a second aspect, an embodiment of the present disclosure provides an image generation method, and FIG. 4 is a flowchart of an image generation method (applied to a server) according to an embodiment of the present disclosure. As shown in FIG. 4, the method is applied to a cloud server, and specifically includes the following steps S31 to S33.

At S31, predicting an eye position at a moment t2 according to an eye position of a user at a current moment t1 and source data sent from a display device, where a first time difference Δt is present between the moment t2 and the moment t1; and obtaining, based on the eye position at the moment t1 and the predicted eye position at the moment t2, an initial gaze area and an initial non-gaze area of the image to be displayed.

Step S31 is the same as step S01, and thus will not be repeated here.

At S32, rendering, according to the initial gaze area and the source data, to obtain low-definition image data and initial high-definition image data.

Step S32 is the same as step S02, and thus will not be repeated here.

At S33, sending the predicted eye position at the moment t2, the initial gaze area, the initial non-gaze area, the low-definition image data, and the initial high-definition image data to the display device, such that the display device determines the low-definition image data and the actual high-definition image data of the image to be displayed and generates the image to be displayed.

In some examples, before sending the predicted eye position at the moment t2, the initial gaze area, the initial non-gaze area, the low-definition image data, and the initial high-definition image data from the cloud server to the display device, the embodiment of the present disclosure further includes:
acquiring a network transmission rate, and judging a relationship between the network transmission rate and a preset rate. If the network transmission speed is lower than the preset rate, only the low-definition image data is sent to the display device. If the network transmission rate is higher than or equal to the preset rate, the low-definition image data and the high-definition data are both sent to the display device.

In other words, a network detection module is added to the cloud server so that when the detected network transmission rate between the display device and the cloud server is lower than the preset rate, only low-definition image data is transmitted while frames of the high-definition image data are dropped, and the display device displays only the low-definition image data, thereby avoiding display stutter by reducing the display resolution. Specifically, the display device acquires an eye position and transmits the eye position to the cloud server. After predicting the initial gaze area according to the eye position, the cloud server performs rendering and anti-distortion on a full field image, and after predicting eye movement information based on the display moment after the rendering, completes rendering of the initial high-definition image data and the low-definition image data. The image is transmitted after the judgment of the network rate is finished. When the network transmission rate is lower than the preset rate, only the full field image (low-definition image data) is transmitted, and a local terminal directly outputs the received image to a system frame buffer for display. When the network transmission rate is higher than the preset rate, the full field image and the high-definition image data are both locally transmitted. After receiving the image information, the local terminal synthesizes the fitted eye movement information, and outputs the synthesized information to the system frame buffer for display.

In a third aspect, an embodiment of the present disclosure provides a display device, and FIG. 5 is a schematic diagram of a display device according to an embodiment of the present disclosure. As shown in FIG. 5, the display device may perform any one of the image generation methods in the first aspect. The display device includes an eyeball tracking module, a first transmitting module, a first receiving module, a judgment module, a data determination module, and an image generation module.

The eyeball tracking module is configured to acquire an eye position in real time.

The first transmitting module is configured to transmit the eye position to a server.

The first receiving module is configured to receive an initial gaze area, low-definition image data, and initial high-definition image data of an image to be displayed from the server. The initial gaze area, the low-definition image data, and the initial high-definition image data of the image to be displayed are obtained by the server through the following steps:
by the server, predicting an eye position at a moment t2 according to the eye position at a moment t1 and source data, and obtaining, based on the eye position at the moment t1 and the predicted eye position at the moment t2, an initial gaze area and an initial non-gaze area of the image to be displayed, where a first time difference Δt is present between the moment t2 and the moment t1; rendering, according to the initial gaze area and the source data, to obtain low-definition image data and initial high-definition image data.

The judgment module is configured to judge whether the acquired actual eye position at the moment t2 is within the initial gaze area.

The data determination module is configured to, in response to the fact that the acquired actual eye position at a moment t2 is within the initial gaze area, take the initial gaze area of the image to be displayed as the actual gaze area of the image to be displayed, and take the initial high-definition image data of the image to be displayed as the actual high-definition image data.

The image generation module is configured to generate an image to be displayed based on at least the low-definition image data of the image to be displayed and the actual high-definition image data.

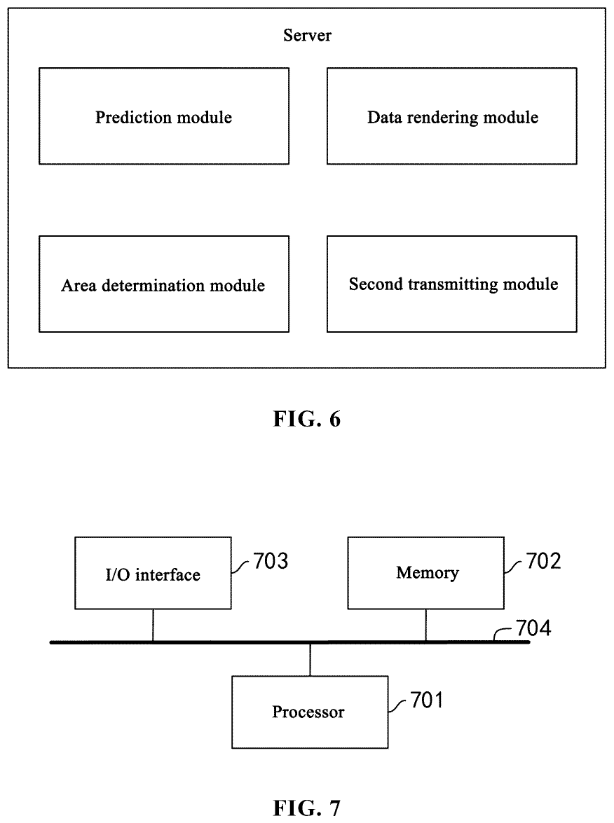

In a fourth aspect, an embodiment of the present disclosure provides a server, and FIG. 6 is a schematic diagram of a server according to an embodiment of the present disclosure. As shown in FIG. 6, the server may perform any one of the image generation methods in the second aspect. The server includes a prediction module, an area determination module, a data rendering module, and a second transmitting module.

The prediction module is configured to predict an eye position at a moment t2 according to an eye position of a user at a current moment t1 and source data sent from a display device, where a first time difference Δt is present between the moment t2 and the moment t1.

The area determination module is configured to obtain, based on the eye position at the moment t1 and the predicted eye position at the moment t2, an initial gaze area and an initial non-gaze area of the image to be displayed.

The data rendering module is configured to render, according to the initial gaze area and the source data, to obtain low-definition image data and initial high-definition image data.

The second transmitting module is configured to send the predicted eye position at the moment t2, the initial gaze area, the initial non-gaze area, the low-definition image data, and the initial high-definition image data to the display device, such that the display device determines the low-definition image data and the actual high-definition image data of the image to be displayed and generates the image to be displayed.

In a fifth aspect, an embodiment of the present disclosure further provides an electronic device, and FIG. 7 is a schematic diagram of an electronic device according to an embodiment of the present disclosure. As shown in FIG. 7, the electronic device includes one or more processors 701, a memory 702, and one or more I/O interfaces 703. The memory 702 has one or more programs stored thereon which, when executed by the one or more processors, cause the one or more processors to implement any one of the display control method described in any one of the above embodiments. The one or more I/O interfaces 703 are connected between the processor and the memory, and configured to enable information interaction between the processor and the memory.

The processor 701 is a device with a data processing capability, including but not limited to a central processing unit (CPU), or the like. The memory 702 is a device with a data storage capability, including but not limited to, a random access memory (RAM, more specifically SDRAM, DDR, etc.), a read-only memory (ROM), an electrically erasable programmable read-only memory (EEPROM) or a flash memory (FLASH). The I/O interface (read/write interface) 703 is connected between the processor 701 and the memory 702 to enable information interaction between the processor 701 and the memory 702, and includes, but is not limited to, a data bus or the like.

In some embodiments, the processor 701, the memory 702, and the I/O interface 703 are interconnected via a bus 704, and further connected to other components of a computing device.

In some embodiments, the one or more processors 701 include a field programmable gate array FPGA.

In a sixth aspect, an embodiment of the present disclosure further provides a computer-readable non-transitory storage medium. The computer-readable non-transitory storage medium has a computer program stored thereon which, when executed by a processor, causes steps of any one of the display control methods described in the above embodiments to be implemented.

In particular, according to the embodiments of the present disclosure, the process described above with reference to the flowchart may be implemented as a computer software program. For example, an embodiment of the present disclosure includes a computer program product including a computer program embodied on a machine-readable medium, where the computer program contains a program code for performing the method illustrated by the flowchart. In such embodiments, the computer program may be downloaded and installed from a network through a communication part, and/or installed from a removable medium. The computer program, when executed by a central processing unit (CPU), causes the functions defined in the system of the present disclosure to be implemented.

It should be noted that the computer-readable non-transitory medium in the present disclosure may be a computer-readable signal medium or a computer-readable storage medium, or any combination of the two. For example, the computer-readable storage medium may be, but is not limited to, an electronic, magnetic, optical, electromagnetic, infrared, or semiconductor system, apparatus, or device, or any combination of the foregoing. More specific examples of the computer-readable storage medium may include, but are not limited to: an electrical connection having one or more wires, a portable computer diskette, a hard disc, a random access memory (RAM), a read-only memory (ROM), an erasable programmable read-only memory (EPROM or FLASH), an optical fiber, a portable compact disc read-only memory (CD-ROM), an optical storage device, a magnetic storage device, or any suitable combination of the foregoing. In the present disclosure, the computer-readable storage medium may be any tangible medium containing or storing a program for use by or in connection with an instruction execution system, apparatus, or device. In contrast, in the present disclosure, the computer-readable signal medium may include a propagated data signal with a computer-readable program code embodied therein, for example, in a baseband or as part of a carrier wave. Such a propagated data signal may take any of a variety of forms, including but not limited to, an electromagnetic signal, an optical signal, or any suitable combination thereof. The computer-readable signal medium may be any computer-readable non-transitory storage medium that is not a computer-readable storage medium, which can communicate, propagate, or transport a program for use by or in connection with an instruction execution system, apparatus, or device. The program code embodied on the computer-readable non-transitory storage medium may be transmitted by any appropriate medium, including but not limited to: wireless, electrical wires, optical cables, RF, and the like, or any suitable combination of the foregoing.

The flowchart and block diagrams in the figures illustrate the architecture, functionality, and operation of possible implementations of apparatus, methods and computer program products according to various embodiments of the present disclosure. In this regard, each block in the flowchart or block diagram may represent a functional block, a program segment, or a portion of a code including one or more executable instructions for implementing the specified logical function(s). It should also be noted that, in some alternative implementations, the functions shown in the blocks may occur out of the order shown in the figures. For example, two blocks shown in succession may, in fact, be executed substantially concurrently, or may sometimes be executed in the reverse order, depending upon the functionality involved. It should also be noted that each block in the block diagram and/or flowchart, and combinations of blocks in the block diagram and/or flowchart, may be implemented by a special purpose hardware-based system which performs the specified functions or operations, or by combinations of special purpose hardware and computer instructions.

It will be appreciated that the above implementations are merely exemplary implementations for the purpose of illustrating the principle of the present disclosure, and the present disclosure is not limited thereto. Various modifications and improvements can be made by those skilled in the art without departing from the spirit and essence of the disclosure. Accordingly, all of the modifications and improvements also fall into the protection scope of the disclosure.

1. An image generation method applied to a display device, comprising:
sending an acquired eye position of a user at a current moment t1 to a server;
receiving an initial gaze area, second-resolution image data, and initial first-resolution image data of an image to be displayed from the server, wherein an image generated corresponding to the initial first-resolution image data has a first resolution, an image generated corresponding to the second-resolution image data has a second resolution, and the first resolution is higher than the second resolution;
wherein the initial gaze area, the second-resolution image data, and the initial first-resolution image data of the image to be displayed are obtained by the server through the following steps: by the server,
predicting an eye position at a moment t2 according to the eye position at the moment t1 and source data, and obtaining, based on the eye position at the moment t1 and the predicted eye position at the moment t2, the initial gaze area and an initial non-gaze area of the image to be displayed, wherein a first time difference Δt is present between the moment t2 and the moment t1; obtaining, according to the initial gaze area and the source data, the second-resolution image data and the initial first-resolution image data;
in response to the fact that an acquired actual eye position at the moment t2 is within the initial gaze area, taking the initial gaze area of the image to be displayed as an actual gaze area of the image to be displayed, and taking the initial first-resolution image data of the image to be displayed as actual first-resolution image data; and
generating the image to be displayed based on at least the second-resolution image data of the image to be displayed and the actual first-resolution image data.

2. The image generation method according to claim 1, further comprising: in response to the fact that the acquired actual eye position at the moment t2 is not within the initial gaze area, determining, based on actual gaze areas and actual first-resolution image data of N frames of display images previous to the image to be displayed, an actual gaze area and actual first-resolution image data of the image to be displayed at the moment t2, where 0<N≤10, and N is a positive integer.

3. The image generation method according to claim 2, wherein the step of determining, based on actual gaze areas and actual first-resolution image data of N frames of display images previous to the image to be displayed, an actual gaze area and actual first-resolution image data of the image to be displayed at the moment t2 comprises:
determining a similarity between the actual first-resolution image data of N frames of display images previous to the image to be displayed and the initial first-resolution image data of the image to be displayed, and a position relationship between the actual eye position at the moment t2 and the actual gaze areas of the N frames of display images previous to the image to be displayed;
taking display images with the actual gaze areas containing the actual eye position at the moment t2, among the N frames of display images previous to the image to be displayed, as candidate display images; and
taking the actual first-resolution image data of a frame in the candidate display images, the actual first-resolution image data of which frame has the highest similarity to the initial first-resolution image data of the image to be displayed, as the actual first-resolution image data of the image to be displayed.

4. The image generation method according to claim 1, wherein the step of generating the image to be displayed based on at least the second-resolution image data of the image to be displayed and the actual first-resolution image data comprises:
acquiring necessary processing performance of the display device for processing the image to be displayed;
in response to the fact that the necessary processing performance does not exceed a preset processing performance threshold, generating the image to be displayed according to the actual first-resolution image data and the second-resolution image data; and in response to the fact that the necessary processing performance exceeds the preset processing performance threshold, clipping the actual gaze area, determining clipped actual first-resolution image data according to the actual first-resolution image data, and generating the image to be displayed according to the clipped actual first-resolution image data and the second-resolution image data.

5. The image generation method according to claim 4, wherein the processing performance comprises a processing speed, and acquiring necessary processing performance of the display device for processing the image to be displayed comprises:
calculating a necessary processing speed of the display device, based on the actual gaze area, the actual non-gaze area, the actual first-resolution image data, and the second-resolution image data of the image to be displayed.

6. The image generation method according to claim 4, wherein the processing performance comprises a processing speed, and acquiring necessary processing performance of the display device for processing the image to be displayed comprises:
acquiring processing speeds of the display device for processing M frames of display images previous to the image to be displayed;
determining, according to the processing speeds for the M frames of display images previous to the image to be displayed, a necessary processing speed of the display device for processing the image to be displayed; where 0<M≤10, and M is a positive integer.

7. The image generation method according to claim 6, wherein determining, according to the processing speeds for the M frames of display images previous to the image to be displayed, the necessary processing speed of the display device for processing the image to be displayed comprises:
determining, according to an average of the processing speeds for the M frames of display images previous to the image to be displayed, the necessary processing speed of the display device for processing the image to be displayed.

8. The image generation method according to claim 4, wherein the processing performance comprises a rendering capability; and acquiring necessary processing performance of the display device for processing the image to be displayed comprises:
acquiring first data information and second data information of the image to be displayed, wherein the first data information comprises at least a number of objects and a number of layers in the actual gaze area, and the second data information comprises at least a number of objects and a number of layers in the actual non-gaze area;
determining a size of an image corresponding to the actual gaze area according to a product of the number of objects in the first data information and a first numerical value; determining a size of an image corresponding to the actual non-gaze area according to a product of the number of objects in the second data information and a second numerical value;
determining, according to the first data information and the second data information, a processing complexity of the actual gaze area and a processing complexity of the actual non-gaze area of the image to be displayed; and
calculating a necessary rendering capability of the display device, according to the processing complexity of the actual gaze area, the processing complexity of the actual non-gaze area, the size of the image corresponding to the actual gaze area, the size of the image corresponding to the actual non-gaze area, a first target resolution and a first target refresh frequency of the actual gaze area, and a second target resolution and a second target refresh frequency of the actual non-gaze area of the image to be displayed.

9. The image generation method according to claim 4, wherein clipping the actual gaze area comprises:
determining, according to the actual eye position at the moment t2 and pre-stored width and height of the gaze area, positions of four vertexes of the clipped actual gaze area; and
clipping the actual gaze area according to the determined positions of the four vertexes of the clipped actual gaze area.

10. The image generation method according to claim 4, wherein the display device comprises a first mode and a second mode; and the method further comprises:
when the necessary processing performance of the display device does not exceed the preset processing performance threshold, respectively predicting, according to the actual non-gaze area, the actual gaze area, the actual first-resolution image data and the second-resolution image data of the image to be displayed, and a current battery level, respective remaining playing time of the display device in the first mode and the second mode;
when the predicted remaining playing time of the display device in the first mode is longer than or equal to playing time preset by a user, generating the image to be displayed according to the actual first-resolution image data and the second-resolution image data;
when the predicted remaining playing time of the display device in the first mode is less than the playing time preset by the user, and the predicted remaining playing time of the display device in the second mode is longer than or equal to the playing time preset by the user, clipping the actual gaze area, determining the clipped actual first-resolution image data according to the actual first-resolution image data, and generating the image to be displayed according to the clipped actual first-resolution image data and the second-resolution image data; and
when the predicted remaining playing time of the display device in the second mode is less than the playing time preset by the user, clipping the actual gaze area, determining the clipped actual first-resolution image data according to the actual first-resolution image data, generating the image to be displayed according to the clipped actual first-resolution image data and the second-resolution image data, and sending prompt information to the user.

11. An image generation method applied to a server, comprising:
predicting an eye position at a moment t2 according to an eye position of a user at a current moment t1 and source data sent from a display device, wherein a first time difference Δt is present between the moment t2 and the moment t1;
obtaining, based on the eye position at the moment t1 and the predicted eye position at the moment t2, an initial gaze area and an initial non-gaze area of the image to be displayed;
obtaining, according to the initial gaze area and the source data, second-resolution image data and initial first-resolution image data, wherein an image generated corresponding to the initial first-resolution image data has a first resolution, an image generated corresponding to the second-resolution image data has a second resolution, and the first resolution is higher than the second resolution; and
sending the predicted eye position at the moment t2, the initial gaze area, the initial non-gaze area, the second-resolution image data, and the initial first-resolution image data to the display device, such that the display device determines the second-resolution image data and the actual first-resolution image data of the image to be displayed and generates the image to be displayed.

12. The image generation method according to claim 11, further comprising:
acquiring a network transmission rate; and
in response to the fact that the network transmission speed is lower than a preset rate, transmitting only the second-resolution image data to the display device.

13. A display device, comprising:
an eyeball tracking module configured to acquire an eye position in real time;
a first transmitting module configured to transmit the eye position to a server;
a first receiving module configured to receive an initial gaze area, second-resolution image data, and initial first-resolution image data of an image to be displayed from the server, wherein the initial gaze area, the second-resolution image data, and the initial first-resolution image data of the image to be displayed are obtained by the server through the following steps: by the server,
predicting an eye position at a moment t2 according to the eye position at a moment t1 and source data, and obtaining, based on the eye position at the moment t1 and the predicted eye position at the moment t2, the initial gaze area and an initial non-gaze area of the image to be displayed, wherein a first time difference Δt is present between the moment t2 and the moment t1; rendering, according to the initial gaze area and the source data, to obtain the second-resolution image data and the initial first-resolution image data, wherein an image generated corresponding to the initial first-resolution image data has a first resolution, an image generated corresponding to the second-resolution image data has a second resolution, and the first resolution is higher than the second resolution;
a judgment module configured to judge whether an acquired actual eye position at the moment t2 is within the initial gaze area;
a data determination module configured to, in response to the fact that the acquired actual eye position at the moment t2 is within the initial gaze area, take the initial gaze area of the image to be displayed as an actual gaze area of the image to be displayed, and take the initial first-resolution image data of the image to be displayed as actual first-resolution image data; and
an image generation module configured to generate the image to be displayed based on at least the second-resolution image data of the image to be displayed and the actual first-resolution image data.

14. A server configured to implement the image generation method according to claim 11, comprising:
a prediction module configured to predict an eye position at a moment t2 according to an eye position of a user at a current moment t1 and source data sent from a display device, wherein a first time difference Δt is present between the moment t2 and the moment t1;
an area determination module configured to obtain, based on the eye position at the moment t1 and the predicted eye position at the moment t2, an initial gaze area and an initial non-gaze area of the image to be displayed;
a data rendering module configured to obtain, according to the initial gaze area and the source data, second-resolution image data and initial first-resolution image data, wherein an image generated corresponding to the initial first-resolution image data has a first resolution, an image generated corresponding to the second-resolution image data has a second resolution, and the first resolution is higher than the second resolution; and
a second transmitting module configured to send the predicted eye position at the moment t2, the initial gaze area, the initial non-gaze area, the second-resolution image data, and the initial first-resolution image data to the display device, such that the display device determines the second-resolution image data and actual first-resolution image data of the image to be displayed and generates the image to be displayed.

15. An electronic device, comprising:
one or more processors;
a memory having one or more programs stored thereon which,
when executed by the one or more processors, cause the one or more processors to implement the image generation method according to claim 1.

16. A computer-readable non-transitory storage medium having a computer program stored thereon which, when executed by a processor, causes steps of the image generation method according to claim 1 to be implemented.

17. An electronic device, comprising:
one or more processors;
a memory having one or more programs stored thereon which,
when executed by the one or more processors, cause the one or more processors to implement the image generation method according to claim 11.

18. A computer-readable non-transitory storage medium having a computer program stored thereon which, when executed by a processor, causes steps of the image generation method according to claim 11 to be implemented.
